(19) United States
(12) Patent Application Publication
(10) Pub. No.: US 2025/0076167 A1
(43) Pub. Date: Mar. 6, 2025

(54) ACTUATOR POSITIONING MECHANISM

(71) Applicant: Tusas- Turk Havacilik Ve Uzay Sanayii Anonim Sirketi, Kahramankazan (TR)

(72) Inventors: Dogukan OZCELIK, Kahramankazan (TR); Huseyin KUTBAY, Kahramankazan (TR)

(73) Assignee: Tusas- Turk Havacilik Ve Uzay Sanayii Anonim Sirketi, Kahramankazan (TR)

(21) Appl. No.: 18/822,324

(22) Filed: Sep. 2, 2024

(30) Foreign Application Priority Data
Sep. 6, 2023 (TR) 2023/011025

(51) Int. Cl. G01N 3/02

(52) U.S. Cl. CPC G01N 3/02

(57) ABSTRACT

The relates to a body (2), at least one actuator (3) that enables structural tests to be performed on the body (2) and is mounted on the body (2) in a removable manner, a ground (Z) on which the actuator (3) is mounted in a removable manner, allowing the actuator (3) to apply load to the body (2), a first state (F) where one end of the actuator (3) is mounted on the ground (Z) and the other end on the body (2), a second state(S) where one end of the actuator (3) is mounted on the ground (Z) and the other end is free, and at least one connector (4) located on the actuator (3), allowing the equipment to be mounted on the actuator (3).

### RELATED APPLICATION

This application claims the benefit of priority of Turkey Patent Application No. 2023/011025 filed on Sep. 6, 2023, the contents of which are incorporated by reference as if fully set forth herein in their entirety.

### FIELD AND BACKGROUND OF THE INVENTION

This invention relates to the mechanism used for fixing and positioning actuators that enable structural tests to be performed.

In structural tests, the loads desired to be given to the test pieces are provided by means of pneumatic, hydraulic or electric actuators (pistons). In cases where the actuators are desired to be operated in idle for adjustment purposes and where the positions of the actuators are adjusted while fixing them to the test pieces, it is desired to keep them perpendicular to the ground or at predetermined angles.

In the utility model document of Chinese origin numbered CN212245923U in the state of the art, a U shaped actuator lifting tool with is explained. In the document, it is mentioned that the U shape lifting tool comprises a lifting ring, a U shaped lifting part and a connecting plate. It is mentioned that one end of the lifting ring is connected to a threaded hole at the upper end of the U shaped lifting tool with a connecting bolt. It is mentioned that the lower part is connected to a connection plate through four open holes at the end of the U-shaped lifting device. It is mentioned that the connection plate is connected to the linear actuator with four connection bolts. When the test actuator needs to be loaded vertically, two workers can lift and fix the actuator.

In the patent document of Chinese origin numbered CN105217440A in the state of the art, a lifting device with a length adjustment hook, based on which the inclination angle can be adjusted for a movable loading beam, is described. In the document, it is mentioned that the lifting device comprises a cross-shaped adjustment hook having a chain ring fixing function. It is also explained that a connecting plate, two force-carrying chain ring hinged shaft bearings, shaft bolt and chain ring fixing slot are included. It is mentioned that the cross-shaped adjustment hook can flexibly adjust the number of sections of force-carrying chain rings on a ring chain lifting rope.

By means of an actuator positioning mechanism realised with the present invention, actuators are securely fixed on the ground in a desired position when not operated.

By means of an actuator positioning mechanism realised with the present invention, assembly of actuators at desired angles on the ground when not operated can be performed more easily and ergonomically in a shorter time and requiring less labour.

### SUMMARY OF THE INVENTION

The actuator positioning mechanism defined in the first claim and the claims dependent on this claim, which is realised in order to achieve the aim of the invention, preferably comprises a body which is an aircraft structural part, and at least one actuator which can be removably mounted on the body and allows structural tests of the body to be performed when mounted on the body. The actuator positioning mechanism comprises a base to which the end of the actuator that is not connected to the body is mounted, allowing the actuator to apply load to the body. There is a first state (F) where one end of the actuator is mounted to the body and the other end to the floor and the actuator applies load to the body, and a second state(S) where the actuator is connected only to the floor with one end and the other end is free. The actuator positioning mechanism comprises at least one connector that allows the user to mount or dismount equipment on the actuator and extends outward from the actuator body.

The actuator positioning mechanism that is the subject of the invention comprises multiple ropes, one end of which is connected to the ground and the other end to the connector, allowing the actuator to be positioned at a predetermined angle to the ground or at an almost perpendicular angle to the ground without tilting over in the second state(S), where the actuator is only connected to the ground at one end and the other end is free.

In one embodiment of the invention, the actuator positioning mechanism comprises at least one valve that allows the user to trigger the actuator and apply load to the body. The actuator positioning mechanism comprises at least one movement arm that is telescopically moved on the actuator, allowing the actuator to apply load on the body via the valve in the first state (F). The actuator positioning mechanism comprises at least one chamber on the actuator, allowing the movement arm to move telescopically on the actuator in the first state (F) or the second state(S), and is placed inside the actuator arm in a form-fitting manner. The actuator positioning mechanism comprises at least one inlet port, which is positioned on the chamber at the end of the chamber that is far from the ground, and allows the movement arm, which is positioned to remain almost completely inside the chamber, to exit the chamber and perform a telescopic movement as a result of the actuator being triggered by the user. The connector is positioned on the chamber in a way that it surrounds the inlet port. The connector is positioned on the inlet port so that it is located on the end of the chamber that is farthest from the ground. The actuator positioning mechanism comprises multiple connection eyebolt positioned on the connector, allowing the other end of the ropes, one end of which are connected to the ground in the second state(S), to be mounted on the chamber, thus allowing the actuator to be positioned on the ground in a manner that is almost perpendicular to the ground or at a predetermined angle to the ground without tilting over in the second state(S).

In one embodiment of the invention, the actuator positioning mechanism comprises multiple fixing eyebolts fixed on the ground, allowing the user to mount or demount the equipment on the ground. The actuator positioning mechanism comprises multiple turnbuckles that are connected to the fixing eyebolts and positioned between the other end of the rope, one end of which is connected to the connection eyebolt, and the fixing eyebolt, and that enable the rope to be brought to a taut position and the actuator to be positioned on the ground in the second state(S) without tilting over.

In one embodiment of the invention, the actuator positioning mechanism comprises a support end located on the ground-facing end of the actuator, allowing the actuator to be mounted on the ground in the first state (F) and the second state(S), and at least one loading end located on the movement arm of the actuator that is opposite the body, allowing the actuator to be mounted on the body in order to apply load to the body in the first state (F).

In one embodiment of the invention, the actuator positioning mechanism comprises multiple fixing eyebolts positioned on the ground with the support end between them. Since the fixing eyebolts, which are positioned opposite each other and with the support end between them, apply force to the connection eye in a direction opposite to each other, the actuator can be positioned on the ground at an angle previously determined by the user in the second state(S) without tilting over.

In one embodiment of the invention, the actuator positioning mechanism comprises multiple turnbuckles positioned so that one of their ends is connected to the fixing eyebolt and the other ends to the ropes. The tensions of the turnbuckles can be adjusted by the user so that they are equal to each other or different from each other depending on the angle at which the actuator will be positioned relative to the ground.

In one embodiment of the invention, the actuator positioning mechanism comprises at least one channel created on the ground to allow the positioning of the actuator on the ground. The actuator positioning mechanism comprises a joint mounted on the support end on the actuator, allowing the actuator to be positioned on the channel in the first state (F) and the second state (S). By means of the joint, the actuator can move in the first state (F) and/or in the second state(S) in a way that changes its angle relative to the ground on a predetermined axis.

In one embodiment of the invention, the actuator positioning mechanism comprises at least one load measuring device that allows the loads applied to the body by the actuator in the first state (F) to be measured, thus allowing the structural test to be performed within the limits predetermined by the user.

In one embodiment of the invention, the actuator positioning mechanism comprises at least one mechanical lock that allows the movement of the loading end and/or the movement arm on the chamber to be stopped in a way that will not damage the body and prevent damage to the loading end in the event that the actuator malfunctions, unexpectedly deactivates and/or the applied load value drops to a value lower than the predetermined load value while applying load to the body in the first state (F).

In one embodiment of the invention, the actuator positioning mechanism comprises an actuator, which is a hydraulic actuator, used in order to perform structural tests on the body. The actuator positioning mechanism comprises at least one transmission apparatus that enables the fluid to be transferred to the actuator, which is a hydraulic actuator, to be triggered by means of a valve in order to move the movement arm in the first state (F) and apply load to the body.

In one embodiment of the invention, the actuator positioning mechanism comprises at least one control unit that enables the actuator to be triggered by the user in the first state (F) and to perform structural tests on the body. The actuator can be adjusted by the user before the first state (F) according to the predetermined structural test loading values and loading times via the control unit. During the structural test, in the first state (F), the fluid control transmitted to the actuator via the valve and the loading values applied to the body via the load measuring device can be displayed simultaneously by the user via the control unit.

### BRIEF DESCRIPTION OF THE SEVERAL VIEWS OF THE DRAWINGS

The actuator positioning mechanism realised to achieve the aim of the invention is shown in the attached figures, and of these figures;

FIG. 1 is the perspective view of the actuator, body and control unit in the second state(S).

FIG. 2 is the front view of the actuator in the first state (F).

FIG. 3 is the perspective view of the eye and support end.

FIG. 4 is the perspective view of the inlet port, connection eyebolt and connector.

### DESCRIPTION OF SPECIFIC EMBODIMENTS OF THE INVENTION

The parts in the figures are numbered one by one and the equivalents of these numbers are given below.
1. Actuator Positioning Mechanism
2. Body
3. Actuator
4. Connector
5. Rope
6. Valve
7. Movement arm
8. Chamber
9. Inlet port
10. Connection Eyebolt
11. Fixing Eyebolt
12. Turnbuckle
13. Support End
14. Loading End
15. Channel
16. Joint
17. Load Measuring Device
18. Mechanical Lock
19. Transmission Apparatus
20. Control Unit
   (F) First State
   (S) Second State
   (Z) Ground

The actuator positioning mechanism (1) comprises a body (2), at least one actuator (3) that enables structural tests to be performed on the body (2) and is mounted on the body (2) in a removable manner, a ground (Z) on which the actuator (3) is mounted in a removable manner, allowing the actuator (3) to apply load to the body (2), a first state (F) where one end of the actuator (3) is mounted on the ground (Z) and the other end on the body (2), a second state(S) where one end of the actuator (3) is mounted on the ground (Z) and the other end is free, and at least one connector (4) located on the actuator (3), allowing the equipment to be mounted on the actuator (3).

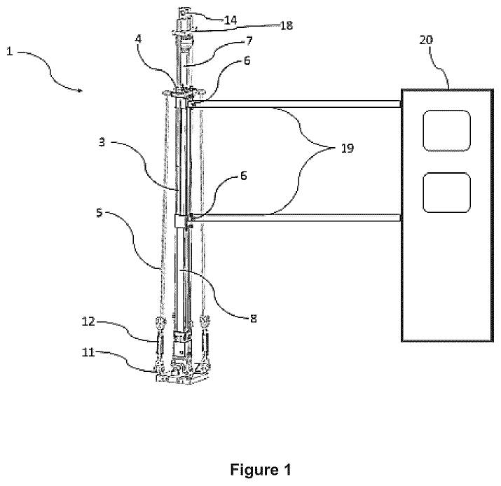

The actuator positioning mechanism (1) comprises multiple ropes (5) one end of which are connected to the ground (Z) and the other end to the connector (4), allowing, in the second state(S), the actuator (3) to be positioned at a predetermined inclination with respect to the ground (Z), thus allowing the actuator (3) to remain balanced in the second state(S) (FIG. 1).

Structural tests are performed on the body (2) in order to determine the mechanical properties of the body (2) on the air and/or space vehicle. Structural tests are performed using actuators (3) that are removably mounted on the body (2). In order to meet the test requirements, actuators (3) are removably mounted and fixed on the ground (Z) during the test. In the first state (F), the movable end of the actuator (3) is mounted on the body (2) and the other end is mounted on the ground (Z) and so the structural tests can be performed on the body (2). In the first state (F), the actuator (3) is positioned at an angle appropriate to the axis on which the structural test will be performed, relative to the ground (Z) in accordance with the structural test to be performed. The second state(S) is where one end of the actuator (3) is mounted on the ground (Z) and the other end is free. The second state(S) covers the cases where the actuator (3) needs to be adjusted before and/or after the structural tests on the body (2) such as load value and load application frequency, and the maintenance and repair of the actuator (3) need to be performed. In order for the user to be able to mount equipment on the actuator (3) in the first state (F) and/or in the second state(S), connector (4) is used. The connector (4) is mounted and positioned on the actuator (3). In this way, external equipment in the first state (F) and/or in the second state(S) can be mounted on the connector (4) in a removable manner.

In the second state(S), in order to be able to perform adjustments on the actuator (3), and to be able to perform maintenance and repair of the actuator (3), the actuator (3) needs to be fixed on the ground (Z) along the direction it extends, preferably almost perpendicular to the ground (Z). In order to position the actuator (3) in accordance with the structural test requirements to be applied to the body (2), it must be positioned by the operator at a predetermined angle to the ground (Z) in the second state(S) and then brought to the first state (F). In order to position the actuator (3) at a predetermined angle to the ground (Z) in the second state(S) or almost perpendicular to the ground (Z), multiple ropes (5) are used, one end of which is mounted on the ground (Z) and the other end on the connector (4). By means of the ropes (5) positioned in a way they are opposite each other in relation to the ground (Z), the actuator (3), which is fixed to the ground (Z) at only one end in the second state(S), is ensured to stop at a predetermined angle to the ground (Z) without tilting over.

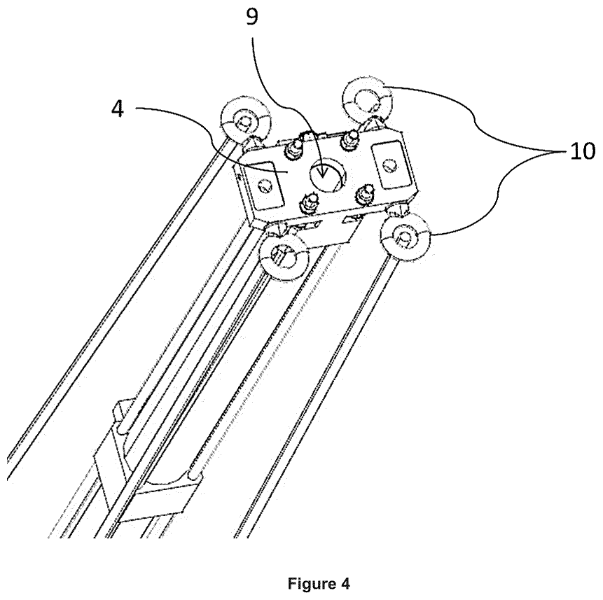

In an embodiment of the invention, the actuator positioning mechanism (1) comprises at least one valve (6) located on the actuator (3) that allows the actuator (3) to be triggered by the user, at least one movement arm (7) that is activated on the actuator (3) by triggering the actuator (3) via the valve (6), at least one chamber (8) that is located on the actuator (3) and allows the movement arm (7) to be retained, at least one inlet port (9) that is located on the chamber (8) and allows the movement arm (7) to be moved out of the chamber (8), connector (4) that is located on the actuator (3) in a way that it almost completely surrounds the inlet port (9), and multiple connection eyebolt (10) that are located on the connector (4) and allow the ropes (5) to be mounted on the chamber (8). The hydraulic fluid that will trigger the actuator (3) is transmitted by the valves (6) located on the actuator (3). In the first state (F), the actuator (3) is triggered to perform structural tests on the body (2) and the movement arm (7) on the actuator (3) is telescopically moved. There is a chamber (8) on the actuator (3) in which the movement arm (7) is placed by moving it towards the ground (Z) in the first state (F) and/or in the second state(S). The chamber (8) has an inside structure that is form-fitting with the movement arm (7) and suitable for the placement of the movement arm (7). During the structural test in the first state (F) and/or on the body (2), the movement arm (7) can be moved by the user from the chamber (8) to the outside of the chamber (8) along the axis where the actuator (3) extends. The chamber (8) and the movement arm (7) provide the telescopic movement function of the actuator (3). The movement arm (7) is placed inside the chamber (8) or moved outwards from the chamber (8) by the inlet port (9) located at the end of the chamber (8) that is far from the ground (Z). The connector (4) is positioned on the chamber (8) in a way that almost completely surrounds the inlet port (9). The connector (4) is positioned on the inlet port (9) in a way that is as far away from the ground (Z) as the length of the chamber (8) in order to balance the centre of gravity in the second state(S) depending on the weight of the actuator (3). By means of the connection eyebolt (10) located on the connector (4), in the second state(S), the actuator (3) is brought to a balance position according to its centre of gravity and positioned almost vertically or at a predetermined angle and inclination relative to the ground (Z) (FIG. 1, FIG. 4).

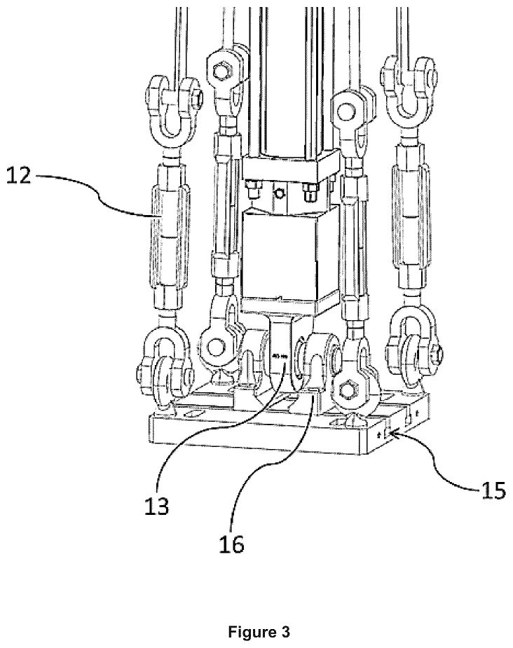

In one embodiment of the invention, the actuator positioning mechanism (1) comprises multiple fixing eyebolt (11) that are located on the ground (Z) and enable the equipment to be mounted on the ground (Z), rope (5) that is removably mounted on the connection eyebolt (10) at one end, and multiple turnbuckles (12) one end of which is to the rope (5) and the other end to the fixing eyebolt (11), allowing the rope (5) to be mounted on the connection eyebolt (10) at a predetermined tension. There are fixing eyebolts (11) on the ground (Z) in order to enable external equipment to be mounted on the ground (Z). In the second state(S), one end of the ropes (5) is mounted on the connection eyebolt (10) on the chamber (8) in a removable manner. The other end of the ropes (5) is mounted on the turnbuckles (12) mounted on the fixing eyebolt (11). In this way, the tensioning of the ropes (5) is ensured in the second state(S) and the positioning of the actuator (3) on the ground (Z) is ensured in a manner that is almost perpendicular or at a predetermined angle to the ground (Z). The ropes (5) that are brought into a taut position by means of the turnbuckles (12) limit the movement of the actuator (3), which is in balance in the second state(S), around the point where it is connected to the ground (Z). After the actuator (3) is placed in the first state (F), the turnbuckles (12) are opened and the ropes (5) are loosened (FIG. 1, FIG. 3).

In one embodiment of the invention, the actuator positioning mechanism (1) comprises at least one support end (13) that allows the actuator (3) to be removably mounted on the ground (Z), and at least one loading end (14) that is located on the movement arm (7) and allows structural tests to be performed on the body (2) by means of the movement arm (7) in the first state (F). In the second state(S), the actuator (3) is kept balanced on the support end (13) that allows it to be mounted on the ground (Z) at a predetermined angle or inclination so that it does not tip over. In the second state(S), the predetermined tension ropes (5) mounted on the turnbuckles (12) and the connection eyebolt (10) mounted on the ground (Z) ensure that the actuator (3) remains balanced on the support end (13). In the first state (F), there is a loading end (14) on the movement arm (7), allowing the movement arm (7) to be mounted on the body (2). The loading end (14) can be removably mounted on the body (2) in the first state (F) and allows the loads to be transmitted to the body (2) during the structural test (FIG. 1).

In one embodiment of the invention, the actuator positioning mechanism (1) comprises fixing eyebolt (11) that allow the actuator (3) positioned on the ground (Z) by means of the support end (13) to be positioned at a predetermined inclination by the user relative to the ground (Z) in the second state(S) and are positioned on the ground (Z) opposite each other with the support end (13) between them. The distances to each other on the ground (Z) and numbers of the fixing eyebolt (11) are determined according to the slope at which the actuator (3) will be positioned in the second state(S) relative to the ground (Z). In order for the user to position the actuator (3) in the second state(S) almost perpendicular to the ground (Z), at least two fixing eyes (11) are positioned opposite each other and the support end (13) is between them. The support end (13) is located on the ground (Z) at an almost equal distance from each fixing eyebolt (11). In this way, the actuator (3) can be positioned in the second state(S) almost perpendicular to the ground (Z). (FIG. 1, FIG. 3)

In one embodiment of the invention, the actuator positioning mechanism (1) comprises multiple turnbuckles (12) one end of which are removably mounted on the fixing eyebolt (11) and the other end to the ropes (5), and that can be adjusted by the user in a way that they will have different or almost equal tensions in the second state(S), thus allowing the actuator (3) to be positioned on the support end (13) at a predetermined inclination with respect to the ground (Z). With the turnbuckles (12) mounted on the fixing eyebolt (11), the ropes (5) are tensioned according to the angle value at which the actuator (3) will be positioned with respect to the ground (Z) in the second state(S). In this way, in the second state(S), the actuator (3) is positioned on the support end (13) in a balanced manner for a period and at an inclination determined by the user, without tilting over (FIG. 3).

In one embodiment of the invention, the actuator positioning mechanism (1) comprises at least one channel (15) located on the ground (Z), and at least one joint (16) that is mounted on the support end (13) in the first state (F) and in the second case(S) to enable the actuator (3) to be positioned at a predetermined inclination with respect to the ground (Z) and is removably mounted on the channel (15). The joint (16) is mounted removably on the ground (Z) by means of the channels (15) located on the ground (Z). By means of the joint (16), the inclination of the actuator (3) relative to the ground (Z) in the first state (F) and in the second state(S) can be changed and the axes in which the actuator (3) can move in the first state (F) can be limited. In the second state(S), by means of the ropes (5) that are tightened, the actuator (3) is prevented from moving on the joint (16) to which it is mounted by means of the support end (13). The actuator (3) is positioned at a predetermined inclination by the user relative to the ground (Z) (FIG. 3).

In one embodiment of the invention, the actuator positioning mechanism (1) comprises at least one load measuring device (17) that is located on the movement arm (7) and allows the measurement of the loads applied to the body (2) in the first state (F). By means of the load measuring device (17), the load value applied to the body (2) by the loading end (14) mounted on the movement arm (7) in a way that will apply load to the body (2) in the first state (F) can be monitored.

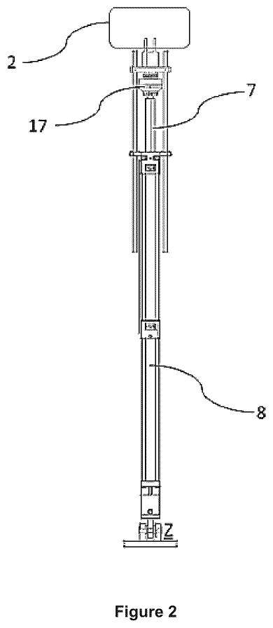

In one embodiment of the invention, the actuator positioning mechanism (1) comprises at least one mechanical lock (18) that is located on the movement arm (7) and allows the movement of the actuator (3) to be limited without causing damage to the loading end (14) in the event of a failure of the actuator (3) in the first state (F). In the first state (F), if a problem occurs on the actuator (3) and/or the movement arm (7) that will prevent the loading test or cause the predetermined loading values to differ, the movement of the movement arm (7) is limited with the mechanical lock (18) to prevent damage to the actuator (3) and the chamber (8) (FIG. 2).

In one embodiment of the invention, the actuator positioning mechanism (1), comprises the actuator (3), which is a hydraulic actuator, and at least one transmission apparatus (19) mounted on the valve (6), enabling the actuator (3) to be triggered and the load to be applied to the body (2) by providing fluid transmission in the first state (F). During structural tests, the actuator (3) is triggered using the hydraulic fluid system. In the first state (F) and/or during the structural test, hydraulic fluid transmission is provided to the actuator (3) via the valves (6) using transmission apparatus (19) in order to trigger the movement arm (7) to perform a telescopic movement from inside the chamber (8) (FIG. 1).

In one embodiment of the invention, the actuator positioning mechanism (1) comprises at least one control unit (20) that allows the actuator (3) to be triggered by the user in the first state (F) and to apply a predetermined amount of load to the body (2), and allows the user to view the data obtained from the load measuring device (17) simultaneously. By means of the control unit (20), before performing the structural test on the body (2) and with the actuator (3) in the first state (F) or the second state(S), the amount of load that the actuator (3) will apply to the body (2) during the structural test and the duration of the load application are adjusted by the user via the control unit (20). When the actuator (3) is moved from the second state(S) to the first state (F), the user sends a command to perform a structural test on the body (2) via the control unit (20). While the structural test is being performed on the body (2), the data read from the load measuring device (17) is transmitted to the control unit (20) and the user can monitor the structural test via the control unit (20) (FIG. 1).

1. An actuator positioning mechanism (1) comprising a body (2), at least one actuator (3) that enables structural tests to be performed on the body (2) and is mounted on the body (2) in a removable manner, a ground (Z) on which the actuator (3) is mounted in a removable manner, allowing the actuator (3) to apply load to the body (2), a first state (F) where one end of the actuator (3) is mounted on the ground (Z) and the other end on the body (2), a second state(S) where one end of the actuator (3) is mounted on the ground (Z) and the other end is free, and at least one connector (4) located on the actuator (3), allowing the equipment to be mounted on the actuator (3), characterised by multiple ropes (5) one end of which is connected to the ground (Z) and the other end to the connector (4), allowing, in the second state(S), the actuator (3) to be positioned at a predetermined inclination with respect to the ground (Z), thus allowing the actuator (3) to remain balanced in the second state(S).

2. The actuator positioning mechanism (1) according to claim 1, wherein at least one valve (6) located on the actuator (3) that allows the actuator (3) to be triggered by the user, at least one movement arm (7) that is activated on the actuator (3) by triggering the actuator (3) via the valve (6), at least one chamber (8) that is located on the actuator (3) and allows the movement arm (7) to be retained, at least one inlet port (9) that is located on the chamber (8) and allows the movement arm (7) to be moved out of the chamber (8), connector (4) that is located on the actuator (3) in a way that it almost completely surrounds the inlet port (9), and multiple connection eyebolt (10) that are located on the connector (4) and allow the ropes (5) to be mounted on the chamber (8).

3. The actuator positioning mechanism (1) according to claim 2, wherein multiple fixing eyebolt (11) that are located on the ground (Z) and enable the equipment to be mounted on the ground (Z), rope (5) that is removably mounted on the connection eyebolt (10) at one end, and multiple turnbuckles (12) one end of which is mounted/connected to the rope (5) and the other end mounted/connected to the fixing eyebolt (11), allowing the rope (5) to be mounted on the connection eyebolt (10) at a predetermined tension.

4. The actuator positioning mechanism (1) according to claim 2, wherein at least one support end (13) that allows the actuator (3) to be removably mounted on the ground (Z), and at least one loading end (14) that is located on the movement arm (7) and allows structural tests to be performed on the body (2) by means of the movement arm (7) in the first state (F).

5. The actuator positioning mechanism (1) according to claim 4, wherein fixing eyebolt (11) that allow the actuator (3) positioned on the ground (Z) by means of the support end (13) to be positioned at a predetermined inclination by the user relative to the ground (Z) in the second state(S) and are positioned on the ground (Z) opposite each other with the support end (13) between them.

6. The actuator positioning mechanism (1) according to claim 4, wherein multiple turnbuckles (12) one end of which are removably mounted on the fixing eyebolt (11) and the other end to the ropes (5), and that can be adjusted by the user in a way that they will have different or almost equal tensions in the second state(S), thus allowing the actuator (3) to be positioned on the support end (13) at a predetermined inclination with respect to the ground (Z).

7. The actuator positioning mechanism (1) according to claim 4, wherein at least one channel (15) located on the ground (Z), and at least one joint (16) that is mounted on the support end (13) in the first state (F) and in the second case(S) to enable the actuator (3) to be positioned at a predetermined inclination with respect to the ground (Z) and is removably mounted on the channel (15).

8. The actuator positioning mechanism (1) according to claim 2, wherein at least one load measuring device (17) that is located on the movement arm (7) and allows the measurement of the loads applied to the body (2) in the first state (F).

9. The actuator positioning mechanism (1) according to claim 4, wherein at least one mechanical lock (18) that is located on the movement arm (7) and allows the movement of the actuator (3) to be limited without causing damage to the loading end (14) in the event of failure of the actuator (3) in the first state (F).

10. The actuator positioning mechanism (1) according to claim 2, wherein the actuator (3), which is a hydraulic actuator, and at least one transmission apparatus (19) mounted on the valve (6), enabling the actuator (3) to be triggered and the load to be applied to the body (2) by providing fluid transmission in the first state (F).

11. The actuator positioning mechanism (1) according to claim 8, wherein at least one control unit (20) that allows the actuator (3) to be triggered by the user in the first state (F) and to apply a predetermined amount of load to the body (2), and allows the user to view the data obtained from the load measuring device (17) simultaneously.
